(19) United States
(12) Patent Application Publication
(10) Pub. No.: US 2011/0203613 A1
(43) Pub. Date: Aug. 25, 2011

(54) MOP BUCKET WITH FILTRATION SYSTEM

(76) Inventor: Owen R. Roberts, Park City, UT (US)

(21) Appl. No.: 12/713,002

(22) Filed: Feb. 25, 2010

(51) Int. Cl. B08B 3/00

(52) U.S. Cl. 134/10; 134/110

(57) ABSTRACT

An improved mop bucket with an integrated water filtration system. A manual or electric pump may be utilized to circulate water from the bucket through the filtration system. The pump may also be utilized to provide water pressure to nozzles that emit streams of water for rinsing the mop head. The filtration system may include one or more filters capable of removing particles and microbes from the water. A germ-killing light, such as an ultraviolet light, may be incorporated into the filtration system to kill any microbes in the water. The mop bucket may be mounted to a wheeled cart to facilitate movement. A re-chargeable battery may be used to provide power to the pump and the germ-killing light.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND

1. The Field of the Present Disclosure

The present disclosure relates generally to implements for use in cleaning floors and other surfaces, and more particularly, but not necessarily entirely, to implements for wetting cleaning heads of mops.

2. Description of Related Art

Traditionally, the process of mopping a floor required nothing more than a bucket and a mop. For example, a traditional process of mopping the floor requires that the bucket first be filled with water. A small amount of detergent, ammonia or floor cleaner is also added, if desired. Next, the head of the mop is dipped into the bucket in order to soak the mop head entirely. Excess water from the mop head is removed by “wringing.” Wringing can be accomplished squeezing the mop head by hand or through use of a mechanical wringer. The mop head is then utilized to scrub the floor. The mop head is occasionally rinsed in the bucket and wrung in order to keep the mop head as clean as possible.

One drawback to traditional mopping techniques is that the mop head is repeatedly rinsed in the bucket after coming in contact with the floor. Thus, after just a single rinse, the water in the bucket may become very dirty. For example, dirt and other debris may be introduced into the bucket each time the mop head is rinsed. Moreover, microorganisms may also be introduced into the bucket each time the mop head is rinsed in the bucket. A user may unwittingly spread additional dirt and microorganisms over an entire surface by repeatedly dipping the mop head into water that becomes increasingly more contaminated after each dip.

The above problem may be exacerbated in commercial settings, where cleaning personnel fail to periodically refresh the water in the mop bucket. In fact, cleaning personnel may go an entire shift without replacing the water in the mop bucket. This problem, however, may not be entirely the fault of the cleaning personnel. For example, in many situations the necessary facilities to change the water in the mop bucket, such as a tap and drain, may simply be unavailable.

The prior art is thus characterized by several disadvantages that are addressed by the present disclosure. The present disclosure minimizes, and in some aspects eliminates, the above-mentioned failures, and other problems, by utilizing the methods and structural features described herein. The features and advantages of the present disclosure will be set forth in the description which follows, and in part will be apparent from the description, or may be learned by the practice of the present disclosure without undue experimentation. The features and advantages of the present disclosure may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 is a perspective view of a mop bucket according to an embodiment of the present disclosure;

FIG. 2 is a diagram of a filtration system for use with the mop bucket shown in FIG. 1;

FIG. 3 is a cross-sectional view of a mop head dryer; and

FIG. 4 is a flow diagram for mopping pursuant to an embodiment of the present disclosure.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed. It must be noted that, as used in this specification and the appended claims, the singular forms “a,” “an,” and “the” include plural referents unless the context clearly dictates otherwise.

According to an aspect of the present disclosure, applicant has discovered an improved mop bucket. An aspect of the applicant's disclosure may include a mop bucket with a liquid extractor, such as a wringer. Another aspect of the applicant's disclosure may include a mop bucket with a liquid recirculating system. The liquid recirculating system may include a pump, either powered or manual, for forcing liquid through a filtration system. The filtration system may be adapted to remove particles and microbes from the liquid. The filtering system may also be adapted to kill microbes in the liquid.

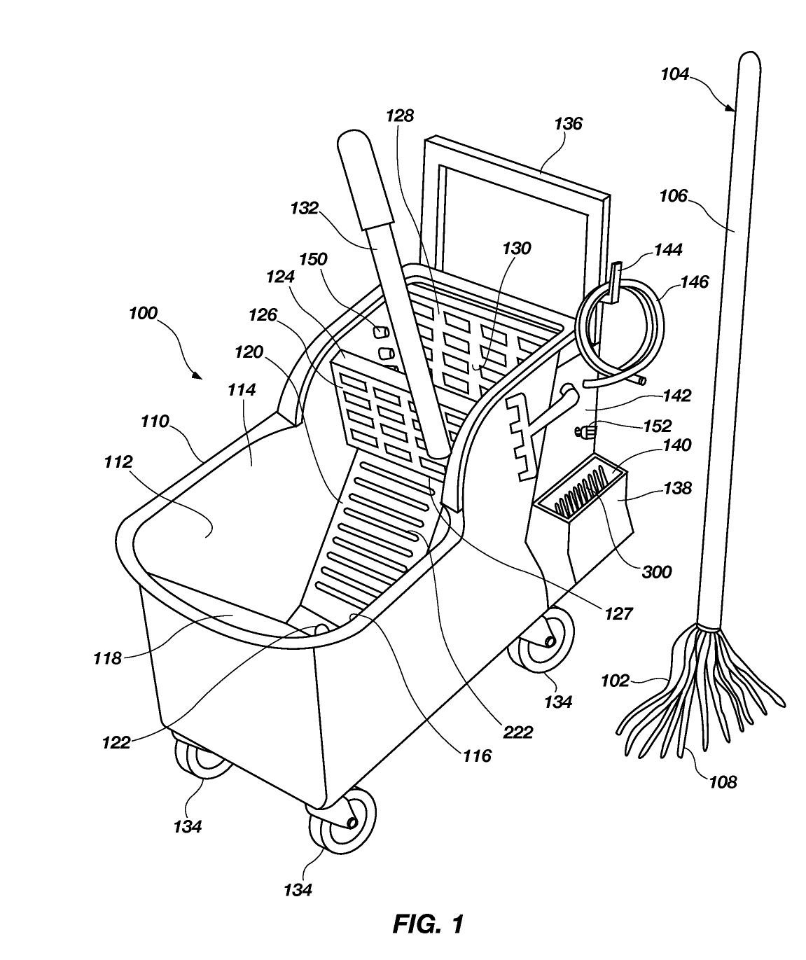

Referring now to FIG. 1, there is depicted a perspective view of an improved mop bucket 100 according to an embodiment of the present invention. The mop bucket 100 may be adapted to rinse a cleaning head 102 of a mop 104. The cleaning head 102 of the mop 104 may be disposed on a distal end of a mop handle 106. The cleaning head 102 of the mop 104 may be utilized to clean a surface, such as a hard floor in a residence or commercial setting, as is known to one having ordinary skill in the art. In an embodiment of the present disclosure, the cleaning head 102 of the mop 104 may include strands of cotton fiber 108. In an embodiment of the present disclosure, the cleaning head 102 of the mop 104 may include any other suitable materials, such as microfiber.

The mop bucket 100 may include a wall 110 defining a reservoir 112 for holding a liquid. In an embodiment of the present disclosure, the liquid may be water. It will be appreciated that the reservoir 112 may hold some other type of liquid, including an off-the-shelf cleaning liquid. The wall 110 may include two opposing wall portions 114 and 116 that may be substantially vertical and parallel to each other. The reservoir 112 may further include a first sloped surface 118 and a second sloped surface 120 for directing liquid in the reservoir 112 into a drain 122. The reservoir 112 may be sized to hold sufficient liquid for wetting the cleaning head 102 of the mop 104. For example, liquid in the reservoir 112 may have sufficient depth to allow the cleaning head 102 to be completely immersed and wetted in the liquid.

The mop bucket 100 may further include a wringer assembly 124 disposed above the reservoir 112. The function of the wringer assembly 124 may be to extract excess liquid from the cleaning head 102 of the mop 104. In an embodiment of the present disclosure, the wringer assembly 124 may include a first side 126 and a second side 128. The first side 126 may be pivotally mounted along its bottom edge 127. The first side 126 and the second side 128 may define a space 130 for receiving the cleaning head 102 of the mop 104.

A lever 132 attached to the first side 126 may be operated by a user to compress the space 130 between the first side 126 and the second side 128 such that any liquid in the cleaning head 102 of the mop 104 is squeezed from the strands 108. The greater the force applied to the lever 132, the more liquid that will be extracted from the cleaning head 102 of the mop 104. The second sloped surface 120 may direct liquid extracted from the cleaning head 102 of the mop 104 back into the reservoir 112 as will be described in more detail hereinafter.

The mop bucket 100 may include caster wheels 134 for facilitating movement. A push handle 136 may be provided for allowing a user to maneuver the mop bucket 100 more easily across a surface. Disposed on the side of the mop bucket 100 may be a dryer 138 for drying the cleaning head 102 of the mop 104. In particular, the dryer 138 may include an opening 140 for receiving the cleaning head 102 of the mop 104. The operation of the dryer 138 will be described in greater detail below.

A rear portion of the mop bucket 100 may include an enclosed compartment 142 for housing a liquid circulation system. As will be explained in greater detail below, the circulation system may include a fluid pathway extending between the drain 122 located at the bottom of the reservoir 112 and a plurality of nozzles or outlets 150 directed into the space 130 between the sides 126 and 128 of the wringer assembly 124.

The fluid pathway may include one or more filters for removing dirt particles and microbes from the liquid. The circulation system may include a pump for pressurizing the system. In an embodiment of the present disclosure, the pump may be electrically powered from one of a battery and an AC power source. A holder 144 attached to the handle 136 may be adapted for storing a drain hose 146. Liquid in the fluid communication path may be directed into the drain hose 146 by a user operated valve. A retractable electric cord 152 may be utilized to connect to a public utility power grid to obtain AC power. In an embodiment of the present disclosure, the hose 146 may be used to fill the reservoir 112 using the pump.

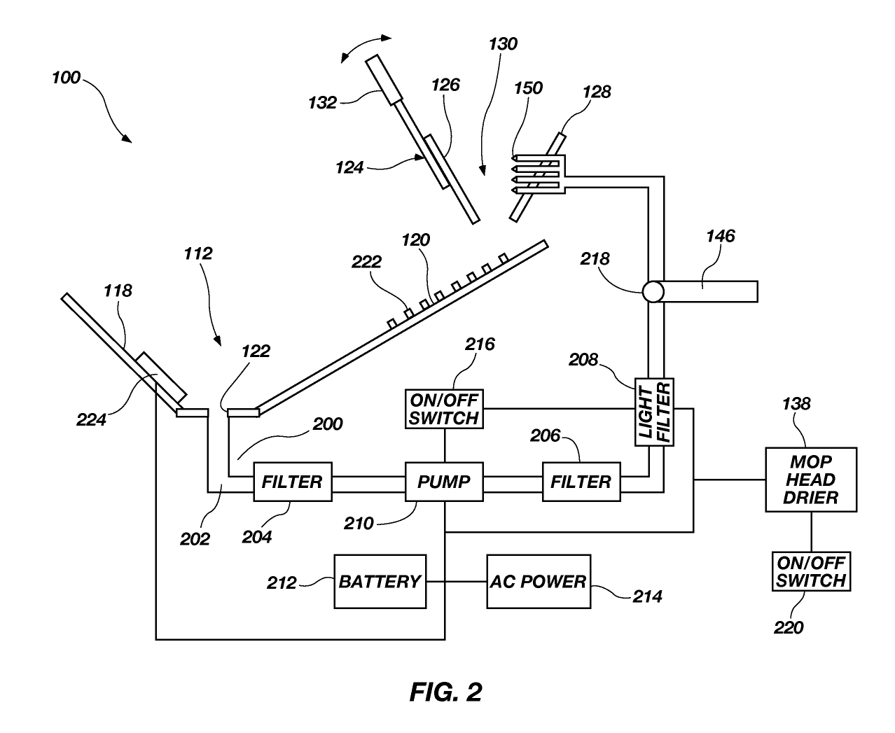

Referring now to FIG. 2, there is depicted a diagram of the mop bucket 100 and an included fluid circulation system 200 pursuant to an embodiment of the present disclosure, where like reference numerals depict like components. The circulation system 200 may include a fluid path 202 extending from the drain 122 at the bottom of the reservoir 112 to the nozzles 150 directed into the space 130 of the wringer 124. The fluid path 202 may include pipes for directing fluid. The fluid circulation system 200 may include a filtering system comprising a pre-filter 204, a filter 206 and a light filter 208. The system 200 may further include a pump 210 for pressuring liquid in the system 200. In an embodiment of the present disclosure, the pre-filter 204, the filter 206, the light filter 208, and the pump 210 may all be housed in the compartment 142 (see FIG. 1). In an embodiment of the present disclosure, the filtering system may include one or more of the pre-filter 204, the filter 206, and the germ-killing light filter 208.

The pre-filter 204 may comprise a filter for capturing larger sediment suspended in the fluid, such as dirt particles and other grime picked up by the cleaning head 102 of the mop 104. The pre-filter 204 may include a cartridge that can be replaced from time to time as needed. The filter 206 may comprise a filter for capturing smaller particles suspended in the fluid and biological agents, such as bacteria and viruses. In an embodiment of the present disclosure, the pre-filter 204 and the filter 206 may comprise activated carbon suitable for filtering purposes. In an embodiment of the present disclosure, the combination of the pre-filter 204 and the filter 206 may be rated to filter particles as small as about 0.5 microns or even smaller. It will be appreciated that other filtering materials other than activated carbon may be utilized with the pre-filter 204 and the filter 206.

The light filter 208 may include a light source designed to specifically kill harmful microorganisms. The light source may be placed in a flow chamber through which liquid from the reservoir 112 is pumped. In an embodiment of the present disclosure, the light source of the light filter 208 may emit ultraviolet (UV) light having a wavelength of about 254 nanometers. In an embodiment of the present disclosure, the light filter 208 may be able to kill or significantly reduce populations of microorganisms in the liquid from the reservoir 112, including populations of bacteria, viruses, molds, algae, yeast, and oocysts.

As mentioned, the fluid circulation system 200 may further include the pump 210 for pressuring liquid in the system 200. In an embodiment of the present disclosure, the pump 210 may be an electric pump. The pump 210 may be powered by one of a battery 212 and an AC power source 214, such as a public utility. The cord 152 (see FIG. 1) may be utilized to connect the pump 210 to an electrical power grid via a wall socket. In an embodiment of the present disclosure, the battery 212 may be rechargeable by the AC power source 214. In an embodiment of the present disclosure, the pump 210 is able to operate on 12 volts provided by the battery 212. In an embodiment of the present disclosure, the pump 210 is able to operate on 110 volts provided by a standard wall socket connected to a public utility.

After the liquid from the reservoir 112 has passed through the filtering system, the liquid is sprayed, under pressure, by the nozzles 150 into the space 130 of the wringer assembly 124. In an embodiment of the present disclosure, the liquid sprayed by the nozzles 150 onto the cleaning head 102 may be utilized to rinse and wash the cleaning head 102 of the mop 104 as it is in the wringer assembly 124.

An on/off switch 216 may be utilized to control the operation of the pump 210. In an embodiment of the present disclosure, the on/off switch 216 may be located on the handle 136 (see FIG. 1). In an embodiment of the present disclosure, the on/off switch 216 for the pump 210 may be activated by the operation of the lever 132 of the wringer assembly 124. For example, the pump 210 may be switched on when the lever 132 is pulled by a user. The pump 210 may operate on a timer. In an embodiment of the present disclosure, a valve 218 may direct liquid in the fluid path 202 into the drain hose 146. This may be useful to empty the reservoir 112 using the pressurization provided by the pump 210. In an embodiment of the present disclosure, the mop bucket 100 may include the dryer 138 for drying the cleaning head 102 of the mop 104. The dryer 138 may be powered by at least one of the battery 212 and the AC power 214. An on/off switch 220 may control operation of the dryer 138.

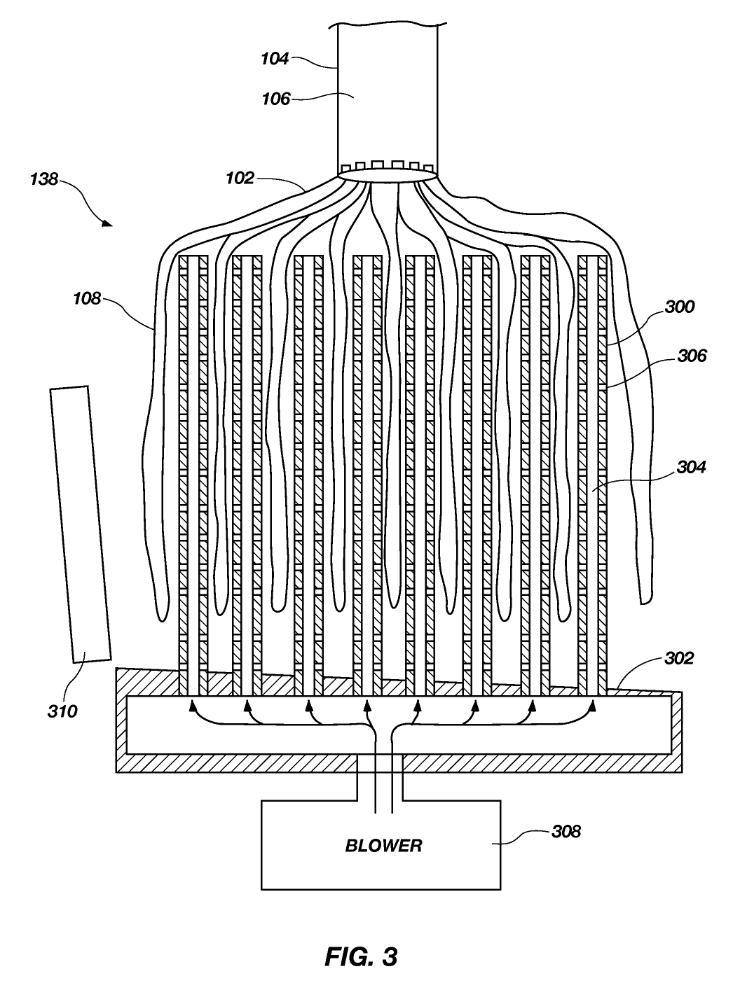

Referring now to FIGS. 1 and 3, the configuration and operation of the dryer 138 will now be explained in more detail. The dryer 138 may include a plurality of slender and elongate hollow posts 300 extending vertically upwards from a sloped base 302. The sloped base 302 provides drainage for any liquid from the cleaning head 102 of the mop 104. Each of the hollow posts 300 may include a central passage 304 for allowing the passage of air. Each of the hollow posts 300 includes a plurality of outlets 306 leading to the central passage 304. The central passage 304 of each of the posts 300 is in communication with a blower 308, which may receive power from the batter 212 or the AC power supply 214.

As can be observed in FIG. 3, the posts 300 are spaced such that the strands 108 of the cleaning head 102 of the mop 104 fall between the posts 300. When activated, the blower 308 blows air into each of the central passages 304 of the posts 300 and then out each of the outlets 306. The blowing air then dries the strands 108 of the cleaning head 102 of the mop 104. In an embodiment of the present disclosure, the dryer may include a vibrator for drying the strands 108. In an embodiment of the present disclosure, heating elements may be utilized to warm the air blown by the blower 308. In an embodiment of the present disclosure, a germ killing light 310 may be incorporated into the dryer 138.

Referring now back to FIGS. 1 and 2, the second sloped surface 120 may extend under the wringer assembly 124 in order to drain liquid extracted from the cleaning head 102 of the mop 104 into the reservoir 112. That is, liquid squeezed from the cleaning head 102 of the mop 104 drips onto the second sloped surface 120 and runs back into the reservoir 112 under the force of gravity. Likewise, liquid sprayed onto the cleaning head 102 of the mop 104 by the nozzles 150 drains from the wringer assembly 124 onto the second sloped surface 120 and then runs under the force of gravity into the reservoir 112.

The second sloped surface 120 may include a plurality of particle traps or riffles 222 for trapping larger particles of dirt and debris picked up from the floor by the cleaning head 102 of the mop 104. The particle traps 222 may comprise projections extending upwardly from the second sloped surface 120. Larger particles of dirt and debris are prevented from travailing into the reservoir by the particle traps 222. In an embodiment of the present disclosure, the second sloped surface 120 may be removable from the mop bucket 100 such that any trapped particles may be dumped into a trash receptacle.

Referring now to FIG. 2, located within the reservoir 112 may be a heater 224 for heating the liquid in the reservoir 112. The heater 224 may include electrical heating elements (not shown). The heater 224 may be connected to at least one of the battery 212 and AC power 214 for power. The heater 224 may heat the liquid to facilitate cleaning. The heater 224 may include a thermostat for regulating temperature of the liquid in the reservoir 112. In an embodiment of the present disclosure, the heater 224 may be placed in line in the circulation system 200. Referring now to FIG. 1, in an embodiment of the present disclosure, the lever 132 may be positioned such that it is operable by either a hand or a foot of a user.

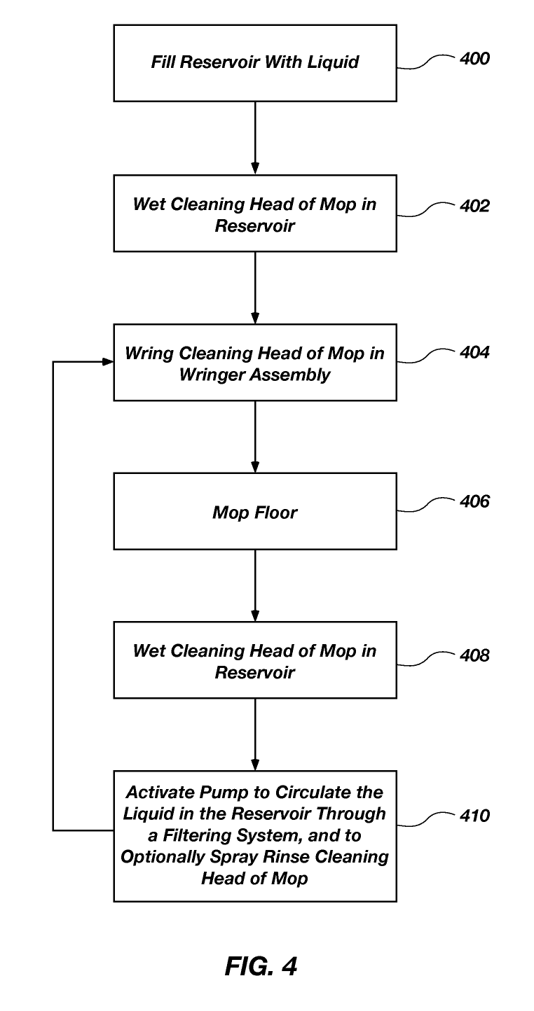

A method of using the mop bucket 100 will now be described pursuant to an embodiment of the present disclosure with reference to FIGS. 1, 2 and 4. At step 400, the reservoir 112 is filled with a liquid, such as water. At step 402, the cleaning head 102 of the mop 104 is wetted in the reservoir 112. At step 404, the cleaning head 102 of the mop 104 is placed into the space 130 in the wringer assembly 124 and wrung. At step 406, the user mops the floor with the mop 104. At step 408, the cleaning head 102 of the mop 104 is dipped into the reservoir 112. At step 410, the pump 210 is activated to filter the liquid in the reservoir 112 through the circulation system 200. Step 410 may further include spray rinsing the cleaning head 102 of the mop 104 using the nozzles 150 while the pump is activated. The method may then repeat back to step 404. An additional step (not shown) may include placing the cleaning head 102 of the mop 104 into the dryer 138 to thereby further dry the cleaning head 102.

It will be appreciated that the wringer assembly 124 may take various forms of mop wringers for extracting liquid from a cleaning head of a mop. In an embodiment of the present disclosure, the wringer assembly 124 may include a pair of rollers. In an embodiment of the present disclosure, the wringer assembly 124 may include a frusto-conical shaped wringer with no moving parts. In this embodiment, liquid extraction occurs as a user twists the handle 106 of the mop 104. As can be observed in FIG. 1, the mop-bucket 100 may be entirely self-contained on a wheeled cart.

Those having ordinary skill in the relevant art will appreciate the advantages provide by the features of the present disclosure. For example, it is a feature of the present disclosure to provide an improved mop bucket with a filtration system. Another feature of the present disclosure to provide such a mop bucket that is capable of removing particles and microbes. It is a further feature of the present disclosure, in accordance with one aspect thereof, to provide a mop bucket which is portable.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description of the Disclosure by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. An apparatus for rinsing a cleaning head of a mop, said apparatus comprising:
a reservoir adapted to hold a liquid;
a wringer disposed above the reservoir, the wringer including a space configured to receive the cleaning head of the mop and extract liquid therefrom;
a filtering system; and
a pump for circulating liquid from the reservoir and through the filtering system to thereby remove unwanted matter from the liquid.

2. The apparatus of claim 1, further comprising a re-chargeable battery for providing power to said pump.

3. The apparatus of claim 1, further comprising:
a drain hose; and
a valve for directing liquid into the drain hose such that the reservoir may be emptied.

4. The apparatus of claim 1, further comprising an electric heater for heating the liquid.

5. The apparatus of claim 1, wherein said filtering system comprises a light source capable of illuminating the liquid with germ-killing light.

6. The apparatus of claim 1, wherein said filtering system comprises a charcoal filter.

7. The apparatus of claim 1, further comprising a sediment trap.

8. The apparatus of claim 1, further comprising a surface for guiding liquid extracted from the cleaning head of the mop by the wringer into the reservoir, wherein said surface includes at least one particle trap.

9. The apparatus of claim 8, wherein said at least one particle trap comprises a plurality of riffles.

10. The apparatus of claim 1, further comprising at least one outlet for directing liquid pressurized by the pump onto the cleaning head of the mop.

11. The apparatus of claim 1, further comprising a lever for providing a force to wring the cleaning head of the mop with the wringer.

12. The apparatus of claim 11, further comprising an electrical switch for activating the pump when the lever is actuated by a user.

13. The apparatus of claim 1, wherein the apparatus is entirely self-contained on a wheeled cart.

14. The apparatus of claim 1, wherein the wringer includes a first surface and a second surface, wherein the first and second surface of the wringer are configured to compress said cleaning head in response to an application of a force.

15. The apparatus of claim 1, further comprising a dryer for drying the cleaning head of the mop, said dryer comprising an electrically powered blower.

16. A method of rinsing a cleaning head of a mop, said method comprising:
(a) wetting the cleaning head of the mop in a reservoir filled with a liquid;
(b) wringing the cleaning head of the mop with a wringer positioned above the reservoir such that liquid extracted from the cleaning head drains into the reservoir; and
(c) activating an electric pump to circulate liquid from the reservoir through at least one filter and then back into the reservoir.

17. The method of claim 16, further comprising rinsing the cleaning head of the mop using liquid pressurized by the electric pump.

18. The method of claim 16, wherein said at least one filter comprises at least one of a germ-killing light and a charcoal filter.

19. An apparatus for rinsing a cleaning head of a mop, said apparatus comprising:
a reservoir adapted to hold a liquid;
a wringer disposed above the reservoir, the wringer including a space configured to receive the cleaning head of the mop and extract liquid therefrom;
a lever for activating said wringer;
a surface disposed below said wringer and extending to said reservoir such that liquid draining from said wringer runs into the reservoir;
at least one particle trap on said surface;
at least one nozzle directed into the space configured to receive the cleaning head of the mop;
a drain in said reservoir;
a circulation system extending from said drain to said at least one nozzle;
an electric pump for pressurizing liquid in said circulation system;
a switch for activating the electric pump;
said circulation system comprising a liquid filtering system comprising at least one of a germ-killing light and a charcoal filter;
a dryer for drying the cleaning head of the mop, the dryer comprising a plurality of hollow tubes extending upwards from a surface, each of said hollow tubes having a plurality of air outlets;
the dryer further comprising an electric blower for moving air through the hollow tubes and out of the air outlets;
a switch for activating the blower;
a drain hose;
a valve for re-directing liquid in the circulating system from the at least one liquid outlet to the drain hose;
a heater for heating liquid in the reservoir;
a power source for providing power to the pump, the dryer and the heater; and
a plurality of wheels for facilitating movement of the apparatus on a surface.

20. The apparatus of claim 19, wherein said power source is at least one of a battery and a public power grid.
